(19) United States
(12) Patent Application Publication
(10) Pub. No.: US 2021/0042701 A1
(43) Pub. Date: Feb. 11, 2021

(54) SYSTEM, METHOD, AND PROGRAM PRODUCT, FOR LOAD BOARD AND LOGISTICS MANAGEMENT

(71) Applicants: Shmuel Ovadia, Miami, FL (US); Ariel Danziger, Miami, FL (US)

(72) Inventors: Shmuel Ovadia, Miami, FL (US); Ariel Danziger, Miami, FL (US)

(21) Appl. No.: 16/989,233

(22) Filed: Aug. 10, 2020

Related U.S. Application Data
(60) Provisional application No. 62/885,210, filed on Aug. 10, 2019.

(51) Int. Cl. G06Q 10/08; G06Q 30/06; G06Q 50/28

(52) U.S. Cl. CPC G06Q 10/08345; G06Q 50/28; G06Q 30/0611; G06Q 10/0833

(57) ABSTRACT

A system for managing logistics of freight loading and movement that, in one version, at least allows carriers to see loads near their origin and destination areas, allows customers to order services based on empty space or load size, provides an application programming interface that is integrated for multiple freight moving companies and multiple storage companies, allows users to look for services/products that accept bids, and allows users to find storage rooms and/or freight carriers with the lowest price per cubic foot.

### CROSS-REFERENCE TO RELATED APPLICATIONS

The present Utility patent application claims priority benefit of the U.S. provisional application for patent Ser. No. 62/885,210 entitled “LOAD BOARD AND LOGISTICS MANAGEMENT SOFTWARE FOR MOVERS”, filed on 10 Aug. 2019, under 35 U.S.C. 119(e). The contents of this related provisional application are incorporated herein by reference for all purposes to the extent that such subject matter is not inconsistent herewith or limiting hereof.

### BACKGROUND OF THE RELEVANT PRIOR ART

This disclosure relates to logistics, aggregation of data and bidding for logistics handling. More specifically, the disclosure relates to data aggregation useful in associating the availability of a driver or transportation resources with demand for transportation. A specific non-limiting disclosed example is data aggregation useful in identifying availability of a driver, and integrating the availability with a bidding system for providing transportation services

One or more embodiments of the presently disclosed method generally relate to shipping and shipments of cargo. More particularly, certain embodiments of the invention relate to the use of an application to track cargo shipping vehicles, order cargo shipping vehicles, determine the best shipping vehicle for the cargo, and prioritize shipments of cargo.

The following background information may present examples of specific aspects of the prior art (e.g., without limitation, approaches, facts, or common wisdom) that, while expected to be helpful to further educate the reader as to additional aspects of the prior art, is not to be construed as limiting the disclosed system, or any embodiments thereof, to anything stated or implied therein or inferred thereupon.

Previous systems describe a method and system for facilitating delivery of shipments by listing items for shipment, listing any requirements for the cargo to be shipped, determining a route for a shipping vehicle to take, allowing shippers to place bids on items for shipment, and track the status of a shipment.

Shipping has historically been executed through a variety of private and publis shipping providers and transportation providers (hereinafter SPTPs) carriers, in which the SPTPs use different business models. Also included are large trucking companies, owner-operators, private fleet carriers, boat shipping lines, planes, airlines, courier and shipment consolidation companies and shipment transport companies following other business models. There are differences in transport capabilities, such as non-bulk cargo (boxes and pallets), bulk, liquid, reefer, flatbeds and cargo container frames. In addition, there are varying capacities within each category.

For purposes of transportation services, a “shipper” may be anyone who requests transportation services from a SPTP. The shipper may be the entity providing goods needing transport. In the alternative, the shipper may be a party receiving goods, and who arranges for transportation services of the goods. The passenger transportation equivalent would be the passenger, although in some cases, the logistical arrangements are fully made without the direct involvement of the passenger. For purposes of this disclosure, “shipper” is intended to mean anyone who commissions transportation services. If specific categories of transportation are specified, the meaning of “shipper” would be limited as required by the categories.

A shipping provider or transportation provider is a business entity that provides transportation. In some cases, the SPTP is an independent driver (owner-operator) or similar, whereas in other case, the SPTP performs most of the contract functions in arranging for loads and scheduling. For purposes of the present disclosure and the claims, unless otherwise specified, SPTPs comprise companies, mobile operators (MOs) and drivers, as well as independent drivers, with the terms used interchangeably.

Typical shipping is accomplished by directly engaging a transport company, such as a package delivery service, shipping by private fleet controlled by the shipper, brokering services and other transport arrangements. In many cases, the transport is performed on a bid basis, using SPTPs such as common carrier haulers.

Private fleets are often established by a manufacturer, distributor or a retailer with distribution facilities, and establishes its own fleet of vehicles, as the private fleet, to meet its own transportation needs. Regardless, private fleets often provide transportation services on the open market, especially in their backhaul (return trip) capacity.

In the case of transportation on a bid basis, this is traditionally accomplished by the shipper sending requests for bids to multiple haulers, at least in the case of land based SPTPs, who function as venders of transportation services. In some cases, the shipper uses a broker or consolidator, who in turn either requests bids from haulers such as SPTPs or other transportation entities or otherwise makes arrangements with haulers. Haulers, on the other hand, seek to obtain shipments in order to maximize their profit. In each case, the ability of the shipper to obtain bids and the ability of the hauler to receive bids is limited to the network and methods they use for sending and receiving bids. In such a case, a shipper and a deadheading hauler may not be aware of each other's availability.

Due to the large volume of requests for shipping quotes, the expected time savings and expected revenue generation, broker services are often used by SPTPs. Broker services can use a bid process or can provide shipping rates based on pre-arranged rate schedules. In addition, the broker service accommodates availability of the SPTP, so that SPTPs are able to use the broker to obtain a load, and the shipping is only arranged for the SPTP for times when the SPTP is actually available to perform the shipping service.

Time constraints are significant factors for the parties to the shipments. The shipper is interested in meeting a time schedule for when a shipment is picked up, is in-transit and delivered. The SPTPs have an interest in being able to closely match the shipper's times, including shipment times for backhaul shipments or other later shipments. The shipper is also time constrained as to work hours and expected time off from work or other obligations.

SPTPs, in maximizing profit, must consider the value of a particularly profitable haul in one direction, as offset by possible losses from deadheading (running empty) back. While it is desirable to have each leg generate a profit, it may be that particular shipments in one direction along a shipping lane may be sufficiently profitable to justify either deadheading or taking a loss in the opposite direction. It may be possible to divert the SPTP or the SPTP's resource in order to increase the return on backhaul trips, but extending the trip time may also result in lost opportunity costs for the more profitable run. In a simplified example, a private fleet may need to balance the need for vehicle availability with the desire for backhaul loads.

Some transportation entities are limited as to geographical area. This can be a matter of preference, or may relate to interstate shipping permits and availability of support facilities. In the case of the SPTP being a private fleet carrier, there is often a preference to limit accepted shipments to backhaul shipments returning from in-house shipments. In addition, transportation entities may or may not engage in international cross-border shipping.

The vehicle capabilities also must be considered. This includes the usual distinctions between chassis type, but there is also some opportunity to extend to different markets. As an example, a reefer can haul a non-refrigerated load on the backhaul.

The shipper may have particular requirements for the shipment. In addition to requirements dictated by the type of goods, the shipper may want to check the transportation entity's reputation, may wish to perform a “pre-load check” to verify adequate insurance or an acceptable safety rating, and may have a desire to track the shipment or provide shipment tracking information to the entity receiving the shipment.

Tracking can be achieved by discrete GPS enabled devices, or through the use of a mobile communication device for which location information is available. For most mobile location-based services implemented at the consumer level, this involves reporting GPS positioning; however, a mobile device is also tracked in the mobile network for purposes of establishing a communications handshake with the mobile telecommunications system as part of the mobile device's roaming and basic communication capability (roaming within or outside of the subscriber network). This is sometimes augmented by GPS tracking, but in many cases identifies the mobile device's location by tower and sector. For purposes of tracking the general location of a vehicle, tracking by use of a mobile device requires consent from the mobile customer. The (US) Telecommunications Act, at 47 CFR § 222, including 47 CFR § 222(f), prohibits telecommunication common carriers from accessing location information for purposes other than system operation without consent of the customer. For this reason, a procedure must be established to assure the tracking service that consent from the mobile device user was obtained. Since the driver may want to know the extent to which the tracking information is used prior to giving consent, it is sometimes not possible to determine whether the driver will accept location tracking and if the driver refuses consent, it may not be possible to obtain actual approval for a particular tracking system.

One of the problems in brokered shipments is that the broker will sometimes not have the information regarding the driver's willingness to accept location tracking. This could be a circumstance of limited communication between the broker and the driver or the driver's employer as a SPTP or could be something of the nature of the extent of location tracking being unclear. For example, a driver may be willing to accept location tracking of the driver's mobile phone but only if limited to cargo tracking or only if limited to cargo tracking and other functions directly associated with the brokerage.

Shipment tracking is finding increasing use. In addition to providing rough estimates of arrival times, shippers and delivery customers often prefer to have information as to when a shipment is expected to arrive. Taken to another level, shippers prefer to have information relating to the approximate current location of the shipment. In addition to “when will the package arrive” information, current location of the shipment can give the shipper and receiver an idea if the shipment has been delayed or other information related to the shipment. Currently, limited tracking is available for package delivery services, but such information is typically given on a warehouse or depot departure and arrival basis.

In “co-brokered” shipments (one broker sources the SPTP and another broker sources the shipper), the broker knows the SPTP and also is able to provide this information to the shipper. In some instances, a brokered shipment is “double-brokered” and the broker that sourced the shipper does not necessarily know who the SPTP is. Consequently, in “double brokered” shipments, the shipper typically does not know who the SPTP is. This is considered undesirable by many shippers, and so the shipper may wish to exclude “double-brokered” bidders if the identity of the SPTP is not known to the shipper. In many cases, double brokering is considered a violation of U.S. law (49 USC § 14916), which imposes an additional legal requirement for identifying the SPTP to the shipper.

“Co-brokering” also involves a shipment agreed to by one broker being fulfilled by a second broker, in which case, the second broker would normally be given the identity of the SPTP.

A reverse auction is a type of auction in which the roles of buyer and seller are reversed. In an ordinary auction (also known as a forward auction), buyers compete to obtain a good or service by offering increasingly higher prices. In the case of a performance bid, such as a response to a Request for Quote (RFQ) or Request for Price (RFP), the bidding does not follow the ordinary auction format. In the case of bidding by SPTPs, the SPTP is the bidder, whereas the shipper selects and accepts a bid. This becomes a “reverse auction” when one or more SPTPs are invited to meet actual or estimated bids, because the SPTP is being asked to bid a quoted amount lower than the lowest bidder.

In view of the foregoing, it is clear that these traditional techniques are not perfect and leave room for more optimal approaches.

### SUMMARY

Transportation services are matched with a specified demand for transportation services in accordance with capabilities and business practices of a transportation service provider providing the transportation services. Information is received indicating availability of the transportation service provider to provide transportation services. Categories of transportation services met by capabilities of the transportation service provider are determined and preference data concerning the transportation service provider is retrieved. At least one category of the retrieved preference data is applied to the transportation service provider for use in combination with the one or more categories of transportation services met by the capabilities of the transportation service provider as a candidate service interest, and the candidate service interest is used to match the transportation service provider to the specified demand for transportation services. Competitive bids are obtained, to meet the specified demand for transportation services, and an offer is made to the transportation service provider to be included in the competitive bids based on the candidate service interest.

If the transportation service provider with the candidate service interest wins the bid, provision of the transportation service is arranged. If the transportation service provider loses the bid, the sequence of using the candidate service interest to match the transportation service provider to the specified demand for transportation services is repeated.

In one aspect of the disclosed technology, a technique is provided for matching transportation services with a specified demand for transportation services in accordance with capabilities and business practices of a transportation service provider providing the transportation services. Information is received indicating availability of the transportation service provider to provide transportation services. One or more computing devices are used to automatically determine one or more categories of transportation services met by capabilities of the transportation service provider. One or more computing devices are used to automatically retrieve preference data concerning the transportation service provider and to apply at least one category of the retrieved preference data to the transportation service provider for use in combination, with the one or more categories of transportation services met by the capabilities of the transportation service provider as a candidate service interest, and non-user-defined preference criteria automatically determined using machine learning. The candidate service interest is used to match the transportation service provider to the specified demand for transportation services. One or more computing devices are used to automatically obtain competitive bids to meet the specified demand for transportation services, and offer the transportation service provider inclusion in the competitive bids based on the candidate service interest. In the case of the transportation service provider with the candidate service interest winning the bid, provision of the transportation service is arranged. In the case of the transportation service provider with the candidate service interest losing the bid, the sequence of using the candidate service interest to match the transportation service provider to the specified demand for transportation services is repeated.

### BRIEF DESCRIPTION OF THE DRAWINGS

The disclosed system is illustrated by way of example, and not by way of limitation, in the figures of the accompanying drawings and in which like reference numerals refer to similar elements and in which:

FIG. 1 shows a general layout for a computer implemented method.

FIG. 2 shows how the method of the current disclosed system would be used.

FIG. 3 shows how the “next leg” function is performed in response to booking a previous load.

FIG. 4 is a block diagram depicting an exemplary client/server system which may be used by an exemplary web-enabled/networked embodiment of the present invention, suitable for executing a regionalized client/server communication system supporting location aware capabilities for providing motion and touch-screen motion commands, in accordance with an embodiment of the present invention.

Unless otherwise indicated illustrations in the figures are not necessarily drawn to scale.

### DETAILED DESCRIPTION OF SOME EMBODIMENTS

The present disclosed system is best understood by reference to the detailed figures and description set forth herein. Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the disclosed system, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the disclosed system is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the disclosed system. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the disclosed system with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the disclosed system. Structures described herein are to be understood also to refer to functional equivalents of such structures. The disclosed system will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the disclosed system disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the disclosed system also includes any novel feature or any novel combination of features disclosed herein either explicitly or implicitly or any generalization thereof, whether or not it relates to the same invention as presently claimed in any Claim and whether or not it mitigates any or all of the same technical problems as does the disclosed system.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the disclosed system.

In some situations, some embodiments of the disclosed system may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the disclosed system.

Where applicable, especially with respect to retail distribution channels of embodiments of the invention, intermediate user(s) may include, without limitation, any individual person or non-human thing benefiting in any way, directly or indirectly, from use of, or interaction with, some aspect of the disclosed system with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the disclosed system may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the disclosed system may be in whole, or in part, replaced with such non-living makers, users, and/or participants with embodiments of the disclosed system. Likewise, when those skilled in the art identify such practical situations where such living makers, users, and/or participants with embodiments of the disclosed system may be in whole, or in part, replaced with such non-living makers, it will be readily apparent in light of the teachings of the disclosed system how to adapt the described embodiments to be suitable for such non-living makers, users, and/or participants with embodiments of the disclosed system. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### Terminology

The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the disclosed system which claims an embodiment “consisting essentially of” or “consisting of” a certain set of elements of any herein described embodiment it shall be understood as obvious by those skilled in the art that the disclosed system also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the disclosed system that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the disclosed system. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the disclosed system.

As is well known to those skilled in the art many careful considerations and compromises typically must be made when designing for the optimal manufacture of a commercial implementation any system, and in particular, the embodiments of the disclosed system. A commercial implementation in accordance with the spirit and teachings of the disclosed system may configured according to the needs of the particular application, whereby any aspect(s), feature(s), function(s), result(s), component(s), approach(es), or step(s) of the teachings related to any described embodiment of the disclosed system may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256 bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the disclosed system can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the disclosed system may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the disclosed system are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the disclosed system need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the disclosed system and likewise, object methods or behaviors can be used to implement the processes of the disclosed system.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the disclosed system may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the disclosed system may be embodied as a system, method or computer program product. Accordingly, aspects of the disclosed system may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosed system may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

Examples provide for a computer system that receives a freight request from a shipper, where the freight request specifies a destination for a load of the shipper. In one embodiment using trucks and trailers, the computer system implements a selection process to select a freight operator to haul a corresponding trailer of the trailer module from a location of the shipper to a destination. The trailer module may be monitored using information. transmitted from the trailer, to determine when the trailer is picked up and/or delivered at the destination.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Moreover, examples described herein can generally require the use of specialized computing devices, including processing and memory resources. For example, one or more examples described may be implemented, in whole or in part, on computing devices such as servers, desktop computers, cellular or smartphones, personal digital assistants (e.g., PDAs), laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and configured to execute the program corresponds to a special-purpose computing device. Furthermore, any computing systems referred to in the specification may include a single processor or may be architectures employing multiple processor designs for increased computing capability.

Furthermore, on or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CL) or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

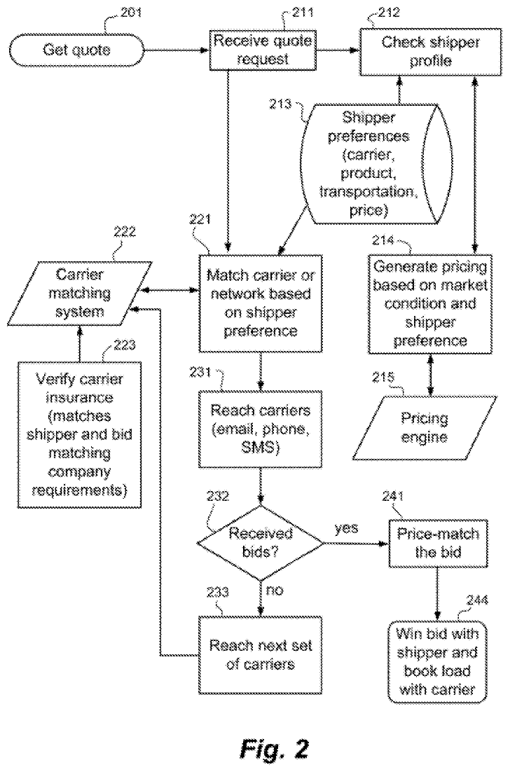

FIG. 2 illustrates a freight system that utilizes modularized trailers, according to one or more examples. In more detail, a freight system 100 implements modularized trailers which a shipper can preload. The preloaded trailer can be assigned to a freight operator using selection criteria that includes proximity of available freight operators to the site of the preloaded trailer. By enabling shippers to generate freight requests for modularized preloaded trailers, the freight system 100 allows for freight operators to receive assignments of freight requests, without a requisite of the freight operator having a trailer to carry the load of the shipment request. Rather, the freight system 100 can select the freight operator on behalf of the shipper, from a pool of operators who would, under conventional approaches, have otherwise worked with carriers to receive pre-scheduled deliveries using trailers of the carrier which the freight operator would have to also load. As examples enable individual freight operators to receive assignments without the freight operators being required to provide trailers, the pool of available freight operators can also be expanded. With a greater number of freight operators, the shipper can receive a more cost-efficient experience from freight operators or carrier.

As described by various examples, a freight system 100 can be implemented as a network service, using a computer system 110 and multiple distributed trailer modules 120. Additionally, the freight system 100 can utilize, or otherwise communicate with computing devices operated by users (e.g., shippers and freight operators). In particular, the freight system 100 may provide a shipper interface, from which a shipper can generate a freight request for a pre-loaded trailer 122. For example, a shipper can interact with an ‘app’ on the shipper's mobile device in order to schedule a freight delivery for an unplanned load. The freight delivery may be planned using a trailer 122 which is provided to the shipper, either before or after the shipper makes the freight request. For example, the shipper may store and/or have ability to use the trailer 122 when needed, but the trailer 122 may be owned by a third entity. While the shipper may retain trailers 122 on-site, such trailers may be managed by the computer system 110, using respective trailer modules 120 that are mounted or otherwise affixed to an interior of the respective trailer. Rather than schedule a freight vehicle carrying a trailer, the freight system 100 enables the shipper to utilize a modularized trailer 122 that can be made available to a larger number of freight operators. Likewise, freight operators can operate independently, without acquiring expensive equipment such as a freight trailer.

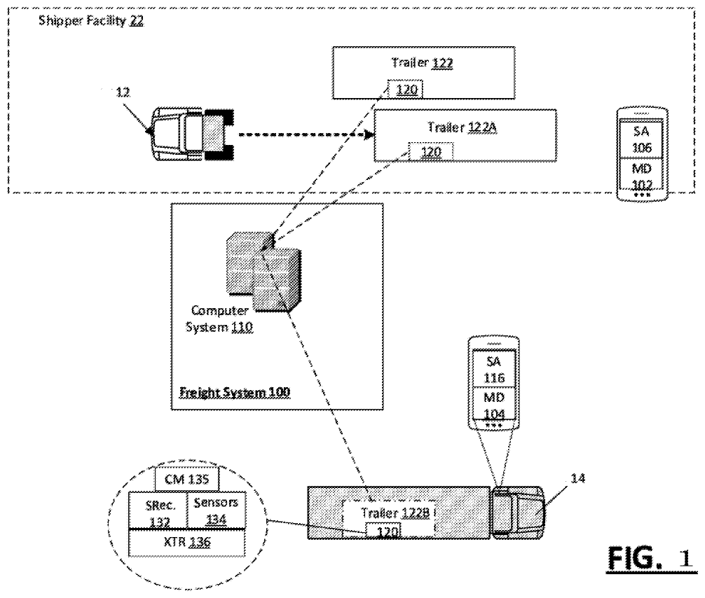

By way of example, FIG. 1 illustrates the computer system 110 monitoring a freight operator that operates a freight vehicle 12 to approach an available pre-loaded trailer 122A at a shipper's facility 22. As described in greater detail, the freight operator may be monitored by the computer system 110 for timely arrival. The freight operator may also be monitored to ensure the freight operator locates the correct pre-loaded trailer 122A. The monitoring performed by the computer system 110 may include providing the freight operator with information and content for locating the pre-loaded trailer 122A. For example, the computer system 110 may have an established communication link with a mobile device of the freight operator in order to communicate information to the freight operator about the location and identifier of the pre-loaded trailer 122A.

As another example, FIG. 1 shows the computer system 110 monitoring another freight operator and vehicle 14 to haul a hitched trailer 122B away to a destination specified by the freight request. The computer system 110 can monitor the progress of the freight trailer to ensure, for example, that the trailer 122B arrives in a timely manner at the destination.

According to examples, freight system 100 includes multiple trailers 122, corresponding trailer modules 120, and multiple mobile devices operated by freight operators and/or shippers. Each trailer module 120 may correspond to specialized equipment, mounted or otherwise provided within the trailer 122, to enable the computer system 110 to remotely monitor the trailer 122. In some examples, the trailer modules 120 are housed as a fixture within the trailer 122. Alternatively, the trailer modules 120 may be individually attached to the interior of the trailer, as needed by the shipper or freight operator. For example, the trailer modules 120 may be charged for power and then coupled to a base station within the interior of the trailer 122 once the trailer is loaded and made ready for pick up.

In some examples, each trailer module 120 includes a satellite receiver 132 to obtain position information (e.g., a Global Positioning System or (GPS)), a set of sensors 134 to detect a physical state (e.g., packed, partially packed, fully packed, etc.) of an interior of the trailer 122, and a wireless transceiver 136 to exchange communications with the computer system 110. The trailer module 120 may also include a power source, such as a battery or a connection to an external power source. In operation, the trailer module 120 may utilize or receive control parameters to implement energy conservation optimizations. For example, the trailer module 120 may modulate the frequency by which communications with the computer system 110 are made. The frequency of the communications may be modulated based on, for example, a physical state of the trailer 122 (e.g., loaded, unloaded, partially loaded), a location of the trailer 122, and/or an operating condition or parameter of the freight vehicle that is to haul the trailer 122. For example, the trailer module 120 may utilize sensors 134 (e.g., optical or interior sensing, accelerometer, gyroscope) or its satellite receiver 132 to detect when the freight vehicle begins hauling the trailer 122. Alternatively, the trailer module 120 may use the sensors 134 and/or satellite receiver 132 to determine when the freight vehicle is at a. suitable highway speed for arriving at the destination of the corresponding freight request on time. The sensors 134 and/or satellite receiver 132 may also be used by the computer system 110 and/or trailer module 120 to detect if the freight operator is not operating the freight vehicle safely. In an example, the computer system 100 and/or trailer module 120 monitor the location of the trailer module 120, as well as characteristics of movement as detected by one or more sensors 134 (e.g., accelerometer, gyroscope) of the trailer module 120, to detect markers of unsafe driving. For example, the computer system 110 and/or trailer module 120 may use the location and sensor data of the trailer module 120 to detect when the corresponding freight vehicle made an abrupt speed or direction change, or when the freight vehicle made a left turn in a crowded region. As an addition or variation, the computer system 110 and/or trailer module 120 may use the sensors 134 to detect an abnormal shift in the cargo of the trailer 122 during transport. In such an example, the computer system 110 and trailer module 120 may trigger a notification to be sent to the freight operator's device.

As an addition or variation, the trailer module 120 may detect indicators of when the freight vehicle is on time with respect to the destination of the freight request. In such cases, the trailer module 120 may power down or otherwise switch to a low power mode to conserve batteries, with cheek-ins of the trailer module 120 occurring a maximum time apart (e.g., several minutes). When the computer system 110 detects that the freight vehicle has fallen behind schedule, the trailer module 120 may be alerted, and more frequent check-in may occur to monitor whether the freight operator can catch up and be on time. Additionally, the trailer module 120, and/or computer system 110 may increase the frequency by which the trailer module 120 is used when, for example, the freight vehicle approaches the destination of the freight request. As a variation, the frequency which the trailer module may be used may alternatively be made subject to an event or condition that justifies increase use of power to monitor the respective freight vehicle and trailer 122.

The computer system 110 can also maintain a roster of freight operators and/or carriers. Each freight operator may correspond to an individual that operates a freight vehicle independently, or alternatively, on behalf of another entity. A carrier may refer to an entity that is responsible for a freight vehicle. In some cases, a freight operator can also be a carrier, but examples also provide for freight operators who can work for multiple carriers. As such, the freight system 100 may provide for the freight operator to operate different vehicles which may be operated under different carriers. Alternatively, the computer system 110 can monitor the freight operator and vehicle separately. Each freight operator may also be provided an operator interface, corresponding to a service application 116 that executes on the operator's mobile device (e.g., personal cellular voice/messaging device) to communicate with the computer system 110. Likewise, shippers may be able to interface with the computer system 110 in a variety of ways, such as through use of a mobile device 102 and service application 106, or through a browser that accesses a web page of the freight system 100. The computer system 110 may also include, for example, a server, or a combination of servers that operate to communicate with the trailer modules 120 and the mobile devices of shippers and/or freight operators (e.g., via respective service applications 106, 116).

Individual trailers 122 which house trailer modules 120 can be packed by the shipper and associated with a freight service request that is received by the computer system 110. The computer system 110 may then implement a matching process to select a freight operator to haul the trailer to a designated destination as specified by the freight service request.

In more detail, each trailer module 120 may include hardware and logic to obtain location information for the module, and to communicate the location information to the computer system 110. Additionally, each trailer module 120 may include sensors and other logic to enable the trailer module 120 to transmit information about a physical state of the corresponding trailer 122, As described in greater detail, a shipper can communicate a freight request to the computer system 110 using, for example, a mobile device on which a shipper interface (e.g., shipper service application) is operated. In connection with making the freight request, the shipper packages a load into one of the respective trailers 122 of the freight system 100. In some examples, the shipper is provided a trailer 122 from a pool of available trailers which reside within a sub-region of the shipper. In variations, one or more available trailers 122 are situated on-site with the shipper in advance of the shipper making the freight request. Still further, the shipper may be provided a reservation for a trailer that is in use. For example, once the reservation is made, a freight operator can drive the empty trailer 122 to the shipper facility 22. Thus, in some examples, the shipper may utilize trailers 122 which are provided by a third-party, either for a specific use or for ongoing use.

In some examples, the trailer module 120 may distribute multiple types of sensors within the interior of the respective trailer 122, in order to facilitate the determination of load information with respect to the packed load. For example, the trailer module 120 may use sensors to determine information such as (i) whether the load is properly packed, (ii) whether there is empty space within the interior of the trailer 122, (iii) the weight of the load, and/or (iv) other information that may be pertinent for selecting a type of freight vehicle to haul the packed trailer.

In some examples, the trailer module 120 may also include one or more control mechanisms 135 for controlling features or aspects of the trailer. By way of example, the control mechanisms 135 may be used to control a digital lock, remotely or through automation, subject to parameters determined by the trailer module 120. In the latter case, the trailer module 120 may determine the current location of the trailer 122, and a digital lock for the trailer may prevent the trailer from being opened until the current location of the trailer 122 is reported by the trailer module to be within a predefined geofence (e.g., within a 100-meter diameter of the destination of a completed freight request).

Further, the trailer module 120 may include one or more local communication interfaces to read sensors distributed within the interior or exterior of the trailer 122, as well as with the freight vehicle. For example, the trailer 122 may be equipped with optical sensors that detect free space within the confines of the trailer. As an addition or variation, the trailer and/or freight vehicle may include tire sensors or break sensors which can detect the presence of a load, as well as whether the load is heavy or light. For example, the tire sensors may indicate presence of a load based on the amount of pressure that is placed on the tire. Likewise, brake sensors may detect presence of a load (or a load that is heavy) based on the amount of strain the sensors measure, with the assumption being that a loaded trailer will exert more strain on the brakes. In other variations, the freight vehicle may include sensors that track the temperature and humidity of the freight vehicle. In some examples, the trailer module 120 may interface with the local sensors of the trailer 122 and/or the corresponding freight vehicle in order to obtain sensor information, which the trailer module 120 can communicate to the computer system 110.

In some examples, the computer system 110 implements a selection process to match the packed trailer 122 with a suitable and available freight operator once the trailer 122 is packed. In some examples, the trailer module 120 communicates output from its sensors and devices to indicate, for example, when the trailer 122 is fully packed or nearly fully packed. In variations, the trailer module 120 can determine when the trailer 122 is packed from other signals, such as from input provided by the shipper via. the shipper's mobile device. Still further, in other variations, the computer system 110 may implement the selection process in advance of the trailer 122 being packed by the shipper. For example, the computer system 110 may implement the selection process to select a suitable freight operator concurrently, while the shipper is packing the trailer 122, so as to remove some lead time from when the selected freight operator would otherwise arrive to take the packed trailer 122. Still further, the shipper may reserve a window of time during which a freight operator can arrive to haul the packed trailer. In such an example, the shipper can make plans to pack the available trailer 122 in anticipation of a pick up during the scheduled window of time, Numerous other variations may also be implemented with respect to the timing of when the computer system 110 implements a selection process to select a freight operator for a given freight request. For example, the computer system 110 may implement the selection process in connection with a monitoring process that monitors the arrival of an empty trailer having a corresponding trailer module 120, for use with the shipper's freight request.

As described with other examples, the computer system 110 may implement the selection process to match a packed trailer 122 with an available freight provider that satisfies a set of criteria of the shipper. The selection process can initially identify freight operators that satisfy a threshold criterion of proximity. For cases in which the freight request is made after the trailer is packed, the threshold criteria can be based on identifying freight operators that are located within the threshold proximity of the shipper site. In some variations, when the shipper has, for example, made a reservation to have the packed trailer picked up, the computer system 110 may make a determination as to which freight operators are available and sufficiently proximate to the site of the shipper to pick up the packaged trailer 122 within the requested time interval. As described with other examples, the selection process may identify a set of criteria from which candidate freight operators are selected, and/or a matched freight operator is identified. By way of example, the set of criteria may include (i) a projected arrival time of the freight operator (e.g., when the freight operator can arrive at the shipper site, irrespective of travel time), (ii) an estimated travel time for the freight operator to arrive at the site of the shipper, (iii) a trip distance for the freight operator to travel from a current location or route to the shipper site, (iv) a capability of the freight operator's vehicle to accommodate a characteristic of the load, (v) a type of vehicle the freight operator is using, and/or (vi) an available amount of service time remaining for the freight operator, where the available amount of service time is the number of continuous hours the freight operator can drive without being subjected to a predetermined rule (such as a regulation, law, policy, etc.) by which the freight operator is to take mandatory rest for a minimum duration of time. In the latter case, the available amount of service time remaining may be compared to, for example, the time needed for the freight operator to pick up the packed freight. The capability of the freight operator's vehicle may become a criterion if, for example, the freight request specifies the load has a particular characteristic, such as size, weight, or need for temperature control.

In some examples, the selection of the freight operator is based on an estimated deadhead cost for the freight operator. The deadhead cost may be based on the amount of time and/or distance that a freight operator would have to operate his or her vehicle, without carrying a load (e.g., without attached trailer, or with empty trailer), in order to arrive at the shipper site. Thus, the deadhead cost may be minimal if a freight operator is found carrying a load to the shipper site, even though the freight operator may arrive later than another freight operator who would have deadhead cost.

Once the freight operator is selected, the computer system 110 may send a confirmation communication to the freight operator, via the freight operator's mobile device. The communication may identify the parameters of the assigned freight request, specifically identifying the destination, as well as other information (e.g., type of load, amount given to carrier for completing request, etc.). if the freight operator accepts the invitation, the freight operator may be guided or otherwise instructed to the shipper site, and specifically to the bay or location of the packed trailer 122. The computer system 110 may identify the packed trailer to the freight operator, using, for example, a numeric identifier that is visible from the outside of the trailer 122.

The computer system 110 may monitor the freight operator to ensure timely arrival. If the computer system 110 determines timely arrival may not be possible, the computer system 110 may reassign the freight request to a different freight operator, depending on the restrictions of the freight request. In some variations, the computer system 110 may communicate with the freight operator (e.g., using the mobile device of the freight operator) to automatically detect when the freight operator is at the shipper site. Once the freight operator is at the shipper site, the computer system 110 can provide the freight operator with additional instructions on locating the packed trailer 122 (e.g., identifying a numerical marker on an exterior of the trailer 122). Still further, in some examples, the freight operator is provided a guide (through the display of various instructional interfaces and/or content, provided through the freight operator's service application) by which the freight operator can take pictures and record information about a physical state of the trailer 122 (e.g., trailer exterior appearance, presence of physical damage to exterior or interior of trailer, the condition of the packed load within the freight, etc.). The pictures or recorded information about the physical state of the trailer may be compared to a threshold quality level or pictures or recorded information taken by the freight operator at the initiation of the freight transport. If the threshold level is not met, the freight operator may be prompted by the computer system 110 to resubmit pictures or recorded information.

In some examples, the computer system 110 independently monitors the freight operator's location (as communicated by the mobile device of the freight operator) and the trailer's location (as determined by the satellite receiver 132 of the trailer module and communicated via its wireless transmitter 136). By monitoring their locations from two sources, the computer system 110 can detect when the freight operator begins hauling the packed trailer 122 out of the shipper's site. The computer system 110 may continue to independently monitor the packed trailer 122 to the destination. In variations, the computer system 110 controls the trailer module 120, or alternatively the trailer module 120 includes logic to self-control and optimize its use of power resources (e.g., battery). In such examples, the trailer module 120 may go to sleep once the determination is made that the selected freight operator is operating the freight vehicle that is carrying the packed trailer 122 of the matched freight service request. Alternatively, the trailer module 120 may operate to check in at a given frequency that can be modulated in response to events or milestones (e.g., passage of time, distance traveled).

The computer system 110 can also guide the freight operator in delivering the packed trailer 122 to the destination. Once delivered, some variations provide that the freight operator is given another guide (e.g., through use of freight operator's service application) to record the physical state of the trailer 122 at time of delivery. For example, the freight operator may be guided to take pictures, and record information about the state of the interior or exterior of the trailer 122, The recorded information may be received and processed by the computer system 110.

In some examples, the computer system 110 can monitor the positioning of a pool of trailers over time, and implement repositioning operations to reposition the individual trailers based on estimated supply and/or demand at various sites. The repositioning operations can include assigning freight operators to haul empty trailers 122 to select sites, or utilizing semi- or fully autonomous freight vehicles in order to haul empty trailers 122 to desired sites (e.g., return back to shipper facility 22)

In some examples, the computer system combines hand held applications, in IOS and Android format, which are in the trucks, warehouses and docks where the freight is picked up and delivered, and provide the ability for shippers to get rates, book and manage shipments from anywhere. Further the system can track empty and partially filled trucks so that shippers can book and fill them, and carriers can update load status by scanning bills of lading and RFID chips and automatically updating shipment location via the location of the truck linked app id.

In the case of a backhaul, next leg, or partially filling leg, the interest of the SPTPs is to find another load to ship or maximize the amount of cargo being shipped if the original load is only a partial load. In this embodiment, the focus is on the driver; however, this is not intended as a limitation, and it is possible that some factors may also apply to a SPTPs. For ease of description, the functions will be described in terms of Obtaining a load or other transportation service for a driver with the understanding that this could apply to other entities such as specialized vehicles in a fleet, boats, planes, or other modes and systems. The system itself is set up with the focus of finding a driver for the shipper.

An automated system is configured to list and accept bids for transportation services. In doing so, bids are taken directly from shipping providers or transport providers (herein after “SPTPs”), from brokers and other intermediaries who in turn seek bids from SPTPs or otherwise obtain bids from SPTPs and other sources. In addition, the bids can be used for bid estimation, in which participating SPTPs may be given an opportunity to engage in a “reverse auction” bid in order to fill a need for obtaining a transportation order. The system can receive bids in email, web, SMS, interactive voice response (IVR), telephone communications not using IVR and other suitable interfaces.

Non-limiting examples of transportation services are shipments of loads and related trucking services. Transportation services can include moving passengers, taxi, car services, and so-called “ride sharing” services in which a central business arranges rides for fares, in which case the load can be a passenger or packages. In each of these cases, the transportation service has at least one origin or destination. While “shipper,” “consignor,” “consignee,” “load,” “hauler” and “shipment” are described in connection with transportation services, the descriptions are given by way of non-limiting examples. Transportation services also includes providing transportation for items other than loads, so that the “shipper” and “load” may be a passenger or other entity submitting the transportation request, and a “shipment” may be the passenger's trip provided as a transportation service.

In many cases. SPTPs use “shipping lanes”, which are origin-destination (consignor-consignee) pairs, generally identified by the general geographical areas of the origin and destination rather than the specific location of the origin or destination. Nevertheless, the “shipping lane” may vary in its specificity, depending on a number of factors. For example, if a long distance haul is performed, the SPTPs may be willing to extend the definition of the shipping lane to cover larger geographic areas for the origin and destination in order to have an easier time to find a return (backhaul) load. To use a specific non-limiting example, if a SPTPs is providing services between New York and San Francisco, an origin or destination in Philadelphia may be within the scope of the shipping lane, but over a shorter distance, Philadelphia may be a significant diversion from a shipping lane whose terminus is New York.

A “backhaul” is a return leg in a simple two leg departure-and-return trip. Some trips include more than two legs, in which case a “next leg” or “subsequent leg” generally connects a series of legs back to the origin. Such trips with more than one “backhaul” leg can be more profitable, in that there is often an imbalance of transportation needs in both directions of a shipping lane, but are more complicated to arrange because they involve additional arrangements for transportation services and because it is not always apparent how to optimize transportation services bookings. In origin and destination (consignor and consignee) oriented transportation services, it is anticipated that an initial trip will have a subsequent leg. In the case of a simple two-way trip, the single subsequent leg or next leg is a “backhaul”, A “deadhead” leg is a leg without a load, but also describes the connection between different termini while empty or not delivering a load.

For purposes of this description, a “round trip” is intended to describe a forward haul in combination with subsequent hauls until the driver returns to a home base. In the case of a forward haul and a backhaul, the “round trip” would be these two legs; however in the case of multiple legs, the “round trip” would include each leg. It is understood; however, that in some cases, a driver will extend the trip through several legs until attempting to return to a home base.

While one SPTP is described as providing the transportation service, it is anticipated that some loads will involve plural shipments. These plural shipments may be performed by one SPTP or may be performed by multiple SPTPs. In the event that the shipment or other transportation service may be split between multiple SPTPs, the system will either permit bidding for portions of the shipment or may post bids for multiple shipments.

In obtaining shipping services, a request for shipment is received. The request includes physical characteristics of the load as relevant to shipping, origin and destination information, time constraints, and other requirements and preferences of the shipper. The physical characteristics of the load include a number of factors which may be relevant to the particular load. For example, full truckload cargos of a particular commodity may not need to identify weight (except for regulatory purposes). On the other hand, some cargos need to be transported with suitable equipment, so some food items may need to be transported by reefer, whereas the reefer may be used for some non-refrigerated goods on a backhaul (or forward haul) or a different leg. Similar restrictions apply to different loads with similar equipment; so for example, a milk tanker could be used to ship diesel fuel on the backhaul, but one would not want to ship milk in that tanker in a subsequent run.

In hauling loads, the SPTPs is likely to want to limit deadheading. Typically, the WTI's will attempt to set up a route with a forward leg and a backhaul in one shipping lane, in which both legs involve a load. In some cases, the trip may involve multiple legs, particularly if a particular leg does not typically have strong demand. While it is possible to remain profitable even if one leg, when taken in isolation, is a loss, the SPTPs will seek overall profitability, and in doing so may accept an unprofitable leg provided acceptance of that less profitable load results in less of a loss than deadheading.

Each of these legs is intended to allow for not exceeding the maximum time that the driver is on the road or that the driver can drive, and other legal restrictions. The legs are further intended to meet other driver and equipment scheduling requirements and any restrictions imposed by the operator or regulations. Additional considerations include necessary turn-around time for the driver at sequential destinations and origins. These turn-around times are dependent on the physical capabilities and local distances between depots, but also depend on the driver's habits and the time and effort of loading and unloading of the cargo.

There are several items that the shipper may either desire or require. These items include the SPTPs meeting legal requirement such as DOT authority, authority to engage in international shipments and endorsements such as hazmat, tanker and double/triple endorsements, and insurance coverage, and acceptable safety record.

The matching of bids for transportation services with users of transportation services can comprise accepting bids for moving cargo by SPTPs for shipments or accepting bids for transporting passengers, as well as other transportation services operating on an “origin/destination” model. The matching of bids can be performed by a method which is initiated by a received transportation request. The request comprises, as necessary, a description of a load or other transportation service, and may, by way of non-limiting examples, comprise:
a generic description of the load,
freight class,
origin location of the load,
destination,
time of availability of the load,
timing requirements for pick-up and delivery,
a requirement for intermediate stops or multiple pickups or deliveries,
weight, physical dimensions or other relevant attributes of the load,
material or product description (if not part of the generic description of the load),
special requirements for the load, such as temperature control (refrigeration or climate control requirements), special handling, etc.,
shipping containers provided,
other physical requirements or characteristic of the load, type and purpose of transport vehicle,
acceptability of multimodal transport or other transport requiring more than one SPTPs or allowing the use of multiple legs,
times of availability at origin and destination, including terminal hours of operation,
regulatory compliance and requirements,
insurance required by e shipper,
value of load,
SPTPs that should be avoided and cannot be used.
required qualifications of the SPTPs, and
other data required by an entity providing the transportation request concerning the transportation request.

The actual details of the description can vary. For example, 40,000 liters of crude oil need not describe many details unless special equipment such as heating equipment is required. Similarly, a standard intermodal cargo van is fairly described by the class or size of cargo van, along with any special requirements such as hazmat requirements.

In addition to the standard descriptions required for engaging SPTPs, additional descriptions can be included. For example, if location tracking of the shipment is desired, the description of the load or other transportation service can include a description of requirements for location tracking.

Using the origin and destination information, a shipping lane is determined, characterizing the transportation request. In some cases, the shipping lane is determined by other characteristics of the load, and these characteristics are taken into consideration when determining the shipping lane. By way of non-limiting example, less than truckload (LTL) shipments may be characterized differently from full load shipments for purposes of determining the shipping lane.

The transportation request is parsed by extracting data in order to obtain criteria needed to fulfill the transportation request. If done correctly, the criteria for the transportation request will be an accurate description of the desired transportation service and the transportation lane. The criteria are then distributed as a request for bids.

There are some bids that are available through third-party bidding or brokerage systems, which may also be automated. Such third-party bidding may be, by way of non-limiting examples, load boards, bid consolidators, and partner businesses who also obtain bids or who identify available SPTPs. Since the third party software may have a different format from that of the disclosed system, the parsed data is matched to the required format for each third party system and is submitted. The bids are received thio email, directly into the system via web interface), phone, mobile SMS, IVR and other suitable interfaces.

Direct bids and bids from third party bidding or brokerage systems are received and evaluated. One or more bids are selected according to predetermined criteria, which may comprise lowest price, category of SPTPs, scheduling, reputation, relationship, third-party intermediate stops and shared cargo space, and willingness to accept location tracking. Since bids are obtained from third party bidding, the disclosed technique creates a “network of networks” by which a shipper or other entity submitting the transportation request can obtain transportation services on a competitive bid basis by using a single contact. Non-limiting examples of third party bidding would be bidding by brokerages, consolidators and other intermediaries. In that way, instead of reviewing separate listings of bid response data from multiple sources, the shipper is able to review prices quoted for all bids in a single action, with desired options presented. The transportation service bids are thereby received from at least one of the respondents, and stored as an aggregated bid database. As a single list, the bids can be arranged in order by category. Some of these categories include options, such as the willingness to accept location tracking or direct shipment from origin to destination without intermediate stops.

For purposes of location tracking, a distinction is made between the driver and other business entities. In many cases, the authority to accept location tracking is with the driver who is generally the subscriber to the mobile device service. If the subscriber of a mobile device used for location tracking is presumed to be the individual, the individual driver would be asked to provide final authorization for location tracking.

The bids are then converted to prices, which are computed based on a commission or a margin that may vary or fee for the service of obtaining and following through with the bids. In many cases, this is a fixed price, but prices may vary in accordance with business need. These prices are provided to the shipper, including information regarding included options as a part of individual bids by using one or more computing devices to calculate a bid commission or margin for applying to render the prices corresponding to the bids. As described here, the “bid” is the amount the SPTPs or SPTPs's representative quotes for the transportation service. The “price” is the amount the shipper pays. The difference between the “bid” and the “price” is the margin.

The prices are quoted to the shipper in an ordered format. The quotes can be arranged according to an order desired by the shipper, such as by price order, by listing according to option, by reputation of the SPTPs or by estimated time for delivery. The shipper then selects a price quote. Alternatively, the shipper may select a priority of criteria by which the SPTPs is selected, which may be, by way of non-limiting examples:
price, if delivered within a specified time period,
price, if delivered within a specified time period but only if the price does not exceed the median of all prices, and
unconfirmed availability of location racking, but only if within 10% of minimum quoted price.

If the shipper first selects a priority of criteria by which the SPTPs is selected, and then elects automatic selection, the SPTPs is selected according to the criteria. One of the advantages of pre-established criteria is that the shipper need not evaluate bids, but rather establish criteria for the bids and await further information regarding the transportation services.

Since there can be a time lag between submission of the bid and the acceptance of the price, there is a possibility that the SPTPs is no longer available upon acceptance. Therefore, upon acceptance, the selected price is matched to the bid and the SPTPs is asked to confirm the acceptance as a confirmed bid. This becomes an agreement to provide services.

If the bid included acceptance of location tracking services, it is still desired to obtain confirmation of acceptance of tracking from the holder of the mobile communication device to be used for tracking. This could be achieved by identifying the mobile number used by the driver. A text message could be sent to the driver asking for confirmation of acceptance of mobile device tracking for the purpose of tracking the delivery. If the driver replies with an acceptance, then that is considered to be an “opt-in” confirmation of acceptance of tracking. Additionally, this confirmation can be established through the driver calling an interactive voice response system or another entity.

The text message may be configured to further obtain permission to use the tracking information to offer loads for a backhaul or “next leg” shipment. That serves two purposes:
1. It obtains consent to the use of the location information for a further purpose; that is marketing of further brokerage services for the “next leg”; and
2. It determines if and when the SPTPs or driver is available for “next leg” transportation services.

It is possible that unexpected circumstances could occur resulting in delay of the driver to an extent that would result in the “next leg” shipment needing to be reassigned. This delay would appear as part of the tracking of the shipment. In such a case, the shipment processing center can use the information to reschedule the driver and find a different resource to service the initial next leg shipment. Permission to use the location data for this purpose (“next leg” scheduling) can be part of the original consent to use location services, or the system can call or text, to obtain permission to use the location data to reschedule the driver. In either case, the driver or SPTPs is made aware of the availability for rescheduling services.

FIG. 2 is a schematic diagram showing the system's interaction with interested parties. FIG. 2 is a schematic diagram showing the system's interaction with interested parties. The process starts with a request to obtain a quote for transportation services (step 201), which may be received from a shipper or other interested party. The quote is received (step 211), and when received, the shipper's profile is checked (step 212), including potentially checking shipper preferences, volume, commitment, financial health, payment history and requirements (step 213). Pricing is estimated based on market condition and shipper preferences or pricing is determined by instantly receiving costing information and applying a margin (step 214), with pricing factors generated by use of a pricing engine (step 215) which can estimate market pricing and uses shipper preferences and attributes to provide pricing estimates according to market conditions and the shipping requirements as specified by the shipper, which are accessed from a shipper database (step 213).

The step of estimating pricing (step 214) provides an estimate of cost. It is common for brokers to estimate their costs using various sources of data, and provide a price during the bidding phase, and once the shipper has accepted this submitted price; the brokerage will then secure transportation resources. The brokerage expects that these transportation resources will be provided at the expected cost or below. The estimated pricing can be used for sonic types of shipments, for example LTL shipments. In such a case, it is possible to estimate instant costing. It is then possible to apply a margin and then generate a price within a short time period. For non-LTL (normal) shipments, a cost and price can be quickly estimated (steps 214 and 215), and once the shipper accepts, the capacity is sourced. For non-LTL “covered pricing only” the system seeks out the carrier first, and once a cost is obtained from the carrier, a price is presented for the shipper to accept or reject.

SPTPs, including SPTPs represented by other networks are matched to the shipper based on preference; service areas and profile metrics of the aggregating carrier and of the SPTPs from that aggregating carrier or the SPTPs directly and bids are solicited (step 221). This may includes providing a carrier matching system (step 222), and may further include matching further requirements such as verification of insurance coverage by the carrier for insurable losses involving the cargo (step 223) and protection from lawsuits resulting from SPTPs involved accidents. Upon identifying SPTPs and networks of SPTPs that are acceptable, the system reaches to the SPTPs and networks of SPTPs to obtain bids for a specific scope of transportation work (step 231). A determination is made if bids are received (step 232), and if not, the system repeats the search for matching SPTPs (step 221).

If bids are received, one or more bids have their costs then marked up to generate associated pricing, to provide prices corresponding to the bids (step 241). By way of non-limiting example, the prices correspond to the bids according to a price-plus-margin calculation; however, if additional services, such as location tracking, are rendered, the corresponding price may be adjusted accordingly. The system or the entity requesting the quote for transportation services selects a bid with its associated pricing and then the system awards the bid and its cost to the SPTPs (step 244).

The automated check conveniently provides a “network of networks” in that the shipper or entity requesting transportation services is able to obtain prices for transporting loads or other transportation services from a single service which obtains bids from different sources and aggregators of different sources. On receipt of a request from a shipper, requests for bids are sent to carriers, directly and indirectly and, if available, additionally one or more on-line networks are automatically queried for bids. These steps are initiated with the bidding process (step 201 in FIG. 2).

The bidding process initially comprises setting up the bid invitation on an on-line database via email, web, SMS, fax or other suitable interface. The bid invitation includes the specifications for the bid, such as full load, weight, commodity, dimensional requirements, and special cargo requirements. Generally loads are bid for carriage on the SPTPs's equipment; however, this can include intermodal carrier chassis and can specify “power only” for trailers in the possession of the shipper.

Further specifications can be either mandatory or optional. A non-limiting example of an optional specification would be the acceptance of location tracking. If a shipper wishes to have location tracking, but is willing to accept non-tracked transportation, the bid would indicate whether the SPTPs has agreed to location tracking. In some cases, the entity entering the bid (e.g., a broker) will not be able to guarantee that the SPTPs will accept location tracking, in which case, the bid can, by non-limiting example, be set to indicate “unknown”.

The LTL pricing database is accessible directly by bidders. In addition, it is possible to scan other shipping logistics databases to obtain bids. In the case of scanning for bids from other shipping logistics databases, it is necessary to determine whether the bid represents “co-brokering” or “double-brokering”. If the bid represents “double-brokering”, the system may determine:
if the double-brokered bid identifies the SPTPs,
if the double-brokered bid permits identification of the SPTPs before acceptance of the bid,
if the double-brokered bid permits identification of the SPTPs only after acceptance of the bid (with or without a right to decline the bid) as a non-limiting example the SPTPs is identified on the bill of lading (BOL),
if the double-brokered bid does not provide identification of the SPTPs, or
whether acceptance of the double-brokered bid would be a violation of law or good business practice.

The check on whether the double-brokered bid would be a violation of law has obvious implications, but also allows the system to seek bids from brokers who would otherwise have concerns about responding to another broker, because assurance would be available that an illegal bid would not be accepted. One of the advantages of automating the check to include double-brokered bids is that the automated system can enforce compliance of carrier disclosure laws and regulations, while at the same time assuring the broker involved in the original bid retains the brokering or bidding relationship with the SPTPs. This also makes it easier to obtain information for location tracking such as the identification (phone number) of a mobile communication device used by the driver, as well as the proper consent for location tracking and for direct follow up with that SPTPs.

As the term implies, multimodal movement exists where and when a load is transported across multiple transportation modes. The most familiar form of this is intermodal freight transport using intermodal containers or ISO containers, sometimes referred to as shipping containers. These containers are designed to be transported by ships or barges, by rail and by truck. In the case of truck transport, ISO containers are typically carried on specialized trailers or semi-trailers, called “frames”. Other multimodal systems include “piggyback” trailers, which use full semi-trailers intended for carriage on specialized railcars. In addition, various forms of cargo are often transported using multimodal systems, such as is implemented by package express companies using a mixture of local delivery trucks, semi-trailers for inter-city transport, and/or air transport. Other forms include, by way of non-limiting example, containerized shipping using various configurations of containers.

When implemented according to the disclosed techniques, the multimodal operation can be through a single provider, or can be separately provided by different SPTPs. This allows SPTPs who do not have combined transportation service or the full desired service area, to make arrangements with other carriers in multimodal transportation to bid for a segment of the multimodal leg, while allowing further arrangements to be made by the disclosed system.

It is anticipated that, in some cases, one or more modes in a multimodal shipment will be used at fixed rates, so that no bid is required for that mode. Such an arrangement expedites the operation of the bid and pricing system by reducing the total number of segments which must be bid. When multimodal bids are included, the shipper may receive a bid that is door to door service or may receive the quoted prices for the multimodal bid, along with non-multimodal bids if the shipper elects to receive both types of bids.

Similar arrangements can be accomplished with people arranging for transportation as a passenger. By way of non-limiting example, instead of separately, arranging individual connections to reach a destination, a person (or persons) can request transportation using the disclosed techniques. While a single mode, such as a car or shared van can be used for the entire trip, the passenger can be offered local service to connect with a train, plane or inter-city bus, and further including local service to the destination. In a functional aspect, this allows someone to arrange for “door to door” service. For example, someone going to or from an airport may be able to use bus service configured for the purpose, but without the need to separately arrange for and separately schedule different services.

Next leg or backhaul bids add the factors that the SPTPs must either obtain a load or deadhead. In the case of the SPTPs or driver wishing to return to home base or another specified location, this also places a constraint on both origin and final destination.

In some cases, the SPTPs has already made arrangements for one leg (typically the front haul) but needs to use a bidding process or negotiate for the other leg or legs. This is often the case with private fleet carriers, but also applies to other situations, such as SPTPs making a delivery for an important client on a headhaul, or a SPTPs with long term contracts and outsourced private fleets. In these cases, there is one leg which is essentially fixed, but the SPTPs can be flexible for other legs within the time constraints of the pre-existing arrangements. The ability to provide multiple legs can even extend to non-economic matters such as the desire of a driver to pass through a particular location perhaps with specific timing.

Most of the time, a SPTPs will bid on a single leg, the front haul or a backhaul, regardless of pre-existing arrangements or contracts. Occasionally, a SPTPs will bid on a round trip or for multiple legs.

The system is capable of using its data to provide information to the SPTPs relevant to selection of optimum routing in terms of estimated revenue cost and profit, and in terms of market demand. This may be done by offering to provide information to the SPTPs concerning optimization of shipping lane selection. If the SPTPs accepts the offer of the optimization information, historic or estimated transportation service data is compared with historic and current data concerning optimization of shipping lane selection, and the SPTPs is provided with revenue, cost and profit estimation for operation along different shipping lanes. By way of non-limiting example, the optimization data may be Obtained by using one of publically available databases, historic data obtained for a plurality of lanes corresponding to at least one origin or destination of the SPTPs. The comparison with revenue, cost and profit estimation is used to generate information indicating at least one of an optimum shipping lane and an optimum time of operation of the transportation service provider. The information concerning the optimum shipping lane and/or optimum time or operation is provided to the SPTPs, who can use the information to select a different shipping lane based on the origin or destination. Alternatively, the information concerning the optimum shipping lane and/or optimum time can be used to invite the SPTPs to submit bids corresponding to the optimum shipping lane and/or optimum time or operation. The information can provide the SPTPs with general estimates of revenue, cost and profit.

By way of non-limiting example, such use of data may be achieved through calculations of optimum routing obtained by the use of one or more computing devices.

For a “next leg” trip, the system relies on a predictive analytics system, in which factors related to demand for transportation services are calculated based on historical and present data. The predictive analytics system accumulates data regarding historic and current bids, and, based on this data, has a capability of guiding the SPTPs as to which lane(s) and even which load(s) to take to maximize any of revenue, gross margin or even operating margin. In addition to the bid and ask on the next leg, the system takes into account or considers the following dynamic inputs when providing this guidance:
Market demand for that lane,
Market supply for that lane,
Carrier cost data, variable and fixed,
Current weather, weather forecast,
Road conditions,
Equipment,
Loading and unloading times, and
Regulatory requirements.

Transportation requests are matched to shipping resources and the SPTPs is matched to the transportation request. At this point, it is possible to request bids from the SPTPs for the shipping lane. Alternatively, since the market for the shipping lane is already known, the system can make a bid offer to the SPTPs and enter that bid. The system can also enter a price for customers, based on the market for transportation services, so that the customer can receive a price equivalent to an anticipated low bid and the SPTPs can be assured a load. Advantages of using calculated market prices are that the SPTPs can ignore the bidding process and await information regarding an assigned leg. A further advantage is that calculated market rates avoid the possibility of shill bidding intended to artificially drive down prices for a particular shipping lane.

Since the disclosed system is able to determine times for the scheduled trip, these times can be used as a basis for a “next leg”. Time estimates related to loading and unloading, as well as other layover times can be added. To this, additional time to deadhead from one destination to a next leg origin is added. In addition, regulatory requirements for rest time and maximum work hours per time period can be calculated, so that an accurate estimate can be made regarding pick-up and delivery. These times are adjusted to accommodate available hours of pick-up and delivery. Since the SPTPs is likely to want to select a location for mandated breaks, the availability of the scheduling information facilitates planning.

The SPTPs can also input additional time for things such as desired break time between loads at a given location, maintenance and meals, as well as providing “breathing room” to reduce time pressure to meet schedules.

It is possible that unexpected circumstances could occur resulting in delay of the driver to an extent that would result in the “next leg” shipment being reassigned. This delay would appear as part of the tracking of the shipment. In such a case, the shipment processing center can use the information to reschedule the driver. Permission to use the location data for this purpose (“next leg” scheduling) can be part of the original consent to use location services, or the system can call to obtain permission to use the location data to reschedule the driver. In either case, the driver or SPTPs is made aware of the availability of rescheduling services.

The system further determines if the SPTPs associated with the accepted bid will accept a further transportation request for a backhaul or additional leg, and if so, the system proceeds to make the determination based on an estimated time of availability. If the SPTPs accepts, a determination is made of a suitable shipping lane. The suitable shipping lane may be defined by the SPTPs, such as “direct return backhaul requested” or can be calculated based on a number of factors. The factors can comprise, by way of non-limiting examples:
permissible deviation from a direct backhaul.
time allowed by the SPTPs before returning to the home base.
demand for transportation services to the home base from intermediate destinations, as determined by historic or current data.
market demand for transportation along different shipping lanes,
regulatory constraints, and
destinations requested by the SPTPs.

The system can also adhere to the bid system by running a reverse auction. In the reverse auction, the bidders for a shipment are given the lowest bid and are given the opportunity to replace with an even lower bid. The SPTPs looking for the load can then compete fairly in the market and in that way avoid deadheading.

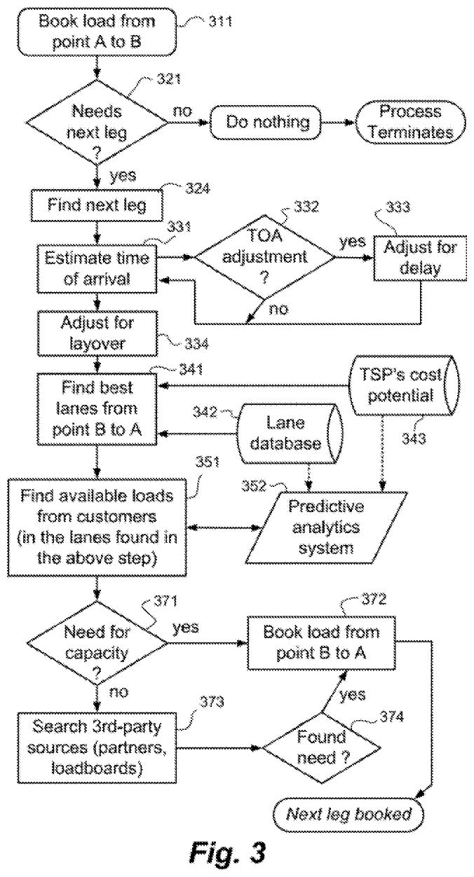

Referring to FIG. 3, the “next leg” function is performed in response to booking a previous load (step 311). The sequence varies from the initial bid process in that the “next leg” function is initiated by the requirements of the SPTPs; however, the financial arrangement for providing transportation services to shippers is similar to that used in the initial bid process.

In response to the booking of the previous load (step 311), a determination is made (step 321) whether the SPTPs requires (requests) a next leg (step 324). If a next leg is not required, the “next leg” function does nothing and the process terminates. If a next leg is requested, a next leg booking process is initiated (step 324). The estimated time of arrival (TOA) is made (step 331), which will be used for scheduling. A determination is made as to whether there is a TOA adjustment (step 332) based on deviations in the tracking location of the present shipment or an external factor such as traffic or weather conditions. If there is a delay, an adjustment to the TOA is made (step 333). The adjustment may be made based on a calculated TOA or may be input to the TOA calculations as an adjustment, but in either case the result is an adjusted TOA. The TOA or adjusted TOA is then adjusted for a layover (step 334). The adjustment for layover may also be recursed to adjust for deadhead time for connecting to the next leg origin location.

The system determines the best lane(s) for the next leg (step 341), based on demand for transportation services, historical demand for transportation services and cost factors, using information obtained from a lane database (step 342) and from considering the SPTPs's variable and fixed cost potentially (step 343). The desires of the SPTPs to remain within a particular geographical territory, the desire of the SPTPs to return to a home base according to a particular deadline and other routing preferences are incorporated in the determination of the best lanes for the next leg (step 341).

Using the “best lanes” information, the system finds available loads from customers (step 351), using a predictive analytics system (step 352). The predictive analytics system uses historic and present data regarding demand for transportation services and historic and present data regarding costs and availability of transportation services along the lane. The use of the predictive analytics system (step 352) allows the system to suggest a competitive cost for providing the transportation services. It is possible to either propose this price as an “accept or reject” offer to the SPTPs and an “accept or reject” price offered to the shipper. Alternatively, the SPTPs can offer the estimated cost as a bid and enter a reverse auction by which the SPTPs competes with other bidders for the “next leg” shipment.

A determination is made if there is a practical match between what the SPTPs is willing to accept to haul one of the matching available loads, and the price the via the system the shipper is willing to pay. If so, the load can be booked. If there is no match, then the system researches sources of loads, to try again to match these to the availability of the SPTPs's next lag capacity, and if such needs are found (step 374) the load is booked (step 372). If a need for capacity exists, then the load is booked; otherwise search third party sources (step 373).

The costs entailed by a hauler can include a number of factors that can be broken down for cost estimation, using data from a cost estimate database. These factors can comprise, by way of non-limiting example, fuel cost and time to divert to pick up and drop off shipment, time, lumper expense and other incidental costs for loading and unloading the shipment, additional fuel costs attributed to carrying the shipment, potential for delay of the truck due to after-hours arrival, apportioned highway taxes and tolls, and lost opportunity costs resulting from the additional time consumed by engaging in the shipment. The cost estimation can then be used by one or more computing devices to calculate revenue, cost and profit.

Since the costs and the market price of transportation services can be determined or calculated, the SPTPs can be offered an amount of compensation for any given trip. This is particularly useful for backhaul or next leg trips, in that the SPTPs can accept the amount without the need to enter the bid process. This places the SPTPs in competition with bidders, but it is possible to include the particular SPTPs and all bidders with a “reverse auction” by which the lowest bidder is submitted for selection by the shipper. Since the SPTPs looking of a next leg is to some extent committed to making the trip, that SPTPs has an incentive to provide a lower bid.

The cost estimates can also be used to determine the cost of deadheading or waiting for a bid, vs. taking a low cost shipment. These estimates can be made granular enough that the SPTPs can describe a cost differential that would render sufficient profit (or reduced loss) for the SPTPs to accept a shipment. Thus the required compensation to compensate the SPTPs for additional fuel, wear and apportioned road use fees can be estimated and compared to a deadhead shipment. As an alternative, the information can be used to give the SPTPs a range of expected prices, so that the SPTPs can elect to wait for a load rather than deadheading.

This bid selection process, such as that depicted in FIGS. 2 and 6, relies on bids received from multiple SPTPs with the focus on finding a carrier for the load. This is essentially focused on the shipper, in which the shipper's load is “shopped” to multiple SPTPs in order to obtain the transportation service for the shipper. This process contrasts with finding a load for a particular SPTPs, in which the focus is on finding a load for the carrier. In order to achieve the goal of finding a carrier for the load (responding to the shipper's request) and finding a load for the carrier (responding to the SPTPs's request), the function of finding a load for the carrier is adapted to function within the framework of finding the carrier for the load. By using historical and present data, it is generally possible for the SPTPs to find a load within a reasonable time frame while offering the shipper competitive bidding as described in connection with FIGS. 2 and 6.

The bidding process for finding a load differs from the bid selection process that focuses on finding a carrier for the load, although the end result remains matching loads to SPTPs. For a given driver, potential loads are ranked to establish a minimal physical parameter match. Criteria comprise, by way of non-limiting examples:
current location,
desired end location or region,
load origin,
load destination,
current location dead-head miles to origin (Do),
desired end location/region dead-head miles to destination (Dd),
origin to destination mileage (M),
rate per mile (R) (ADo+BDd)/(CM*DR).

In calculating rate per mile, smaller numbers for dead-head miles are ranked lower (zero is ideal—no dead-head miles, long trip, high rate).

Driver provided profile data are also used when ranking loads. Driver data may be used to change calculated factors or factors determined by historical information concerning the driver, or may be used to supplement stored or calculated data. Potential loads are filtered based on driver optionally defined parameters or profile information. Such profile information may comprise, by way of non-limiting examples:
headquarters,
equipment type (van, reefer, flatbed),
equipment details (53′, 48′, temperature range, specialized capabilities),
favorite lanes,
load descriptions,
geography serviced or operating jurisdictions,
preferred time of day,
preferred day of week,
toll sensitivity,
single/multi-stop,
team loads.

The driver is also permitted to choose negative associations, e.g., no hazardous materials.

External public data sources are also provided as a data input to filter potential loads. Such external data comprises, by way of non-limiting example in-based transient loads.

Non-driver related parameters that limit the physically possible options are used to filter potential loads. Non-driver related parameters comprise, by way of non-limiting examples:
pick-up window (or distance to pick up),
delivery window,
traffic data,
weather,
fuel prices,
road repairs,
regulatory limitations,
toll roads.

Driver load history based on previous use of the disclosed system is useful for determining potential loads. While the driver can change most of these preferences, driver history provides a good starting point to evaluate which loads will be preferred by the driver. Criteria for filtering potential loads based on driver load history with the disclosed system can comprise, by way of non-limiting examples:
lanes,
pricing,
win/loss ratio,
cancellations,
on-time delivery.

Machine learning is used to determine non-user defined preferences and add to the driver's profile for filtering and ranking. These become inferred positive and negative preferences. Non-limiting examples are:
Learn driver positive preferences from common values in loads selected for bid: lanes, geography, pricing/rates, equipment type. Add this to the driver's non-user defined profile.
Learn driver negative preferences from declined loads: deadhead distance (e.g., not more than 100 miles), timing (e.g., evening driver, or no northern loads in winter), geography (e.g., no dense urban areas, no mountainous lanes), rates (e.g., nothing under $2/mile), equipment (e.g., no reefers) and add to the driver's non-user defined profile.
Show specific loads for the purposes of determining driver preferences: e.g., show three different equipment types in the first three loads to determine their equipment preferences, show three different destination regions with the same origin to determine a geographical preference. Get the driver to reveal their behaviors by their positive and negative responses to contrasting loads.

It is also possible to provide a more direct “learning” mode that does not show real loads but instead is an opportunity to interview the driver for their preferences instead of requiring the driver to fill out a form. In the learning mode, loads are carefully presented that will reveal their ranking by the particular driver. The driver is then offered a review of final selections for refinement of preferences. In general, much of the data used is considered predictive of preference. Since the preferences are straightforward, the driver is able to make changes to the preferences, and therefore, most of the rendered data can be changed by the driver. The review affords the benefits of automated evaluation of preferences while avoiding restricting the driver to the automated selection process.

The learning mode has the advantage of reducing the effects on the learning process of variables that change over time but are otherwise unrelated to the driver's general preferences. Similarly, by examining driver preferences under a single test sequence, it is possible to avoid distorting the preferences by reading segments of the driver's preferences at different times under different circumstances. Additionally, the learning mode allows the system to recognize driver preferences at an early stage instead of relying solely on developing a bidding history.

During selection, it is possible to look ahead for ranking based on real-time behaviors. For example, if a driver just picked up a load for a dry van, it is possible to re-rank based on the tighter criteria. In doing this, the system pre-calculates a tree of potentials based on yes/no responses for quick turn-around of next potential load. In the example, the driver may indicate a refrigeration capacity, so that even though a dry van load was previously carried, the driver is able to accept refrigerated loads.

It is possible to infer a desired front-haul or backhaul based on loads accepted and other data relating to the driver. An attempt to detect front-haul and backhaul trips is based on loads. The loads selected for consideration and any set parameters e.g., a specific origin (e.g., Dallas) and a non-specific destination (East Coast) may indicate a backhaul. If a back-haul detected, the system will look for multi-stop returns. An origin near their headquarters may indicates a front-haul. If front-haul detected, a backhaul is recommended after selection of the front-haul trip.

Multiple load options are offered for consideration in parallel so driver can prioritize, bid or reject simultaneously. The driver is allowed to make a selection from the multiple-load options. The trips are sorted on all criteria and the criteria and selections are used to infer driver preferences. This selection encourages a rough sort of several loads followed by a final review to pick the best fit. This provides a greater volume of general data for positive/negative preferences as well as fine tuning on positive preferences. The results are inferred preferences from parallel/grid presentation and search criteria.

The preferences are evaluated as absolute preferences, preferences which are not absolute, but which are considered along with other factors, and preferences that are considered competitively. An absolute preference would be a criterion which would cause a driver to decline a load under most or all circumstances. A non-absolute preference would a factor which would enter into the driver's decision to accept a bid or which would result in the driver either having a strong incentive to obtain the load (favorable preference), or which would result in a relatively high bid or to decline to bid (unfavorable preference). A competitive preference is similar to a non-absolute preference in that it would result in an incentive to obtain the load or to bid high.

The preferences establish a predetermined threshold, which is either absolute or relative. An absolute threshold would be one that is not significantly affected by competition, whereas a relative threshold is one that is established by viewing the availability of competition.

In the case of a particular backhaul, comparisons are made between nonstop backhauls and multi-leg backhauls. The considerations are the additional time, distance and deadhead distance to accept two separate loads making up two segments, vs taking a single load to the end destination. This takes into consideration supply and demand, dead-head miles to a “hot” market origin and routing through “hot” markets for multiple stops for higher payments.

Thus, the disclosed system is not limited to any particular tangible means of implementation.

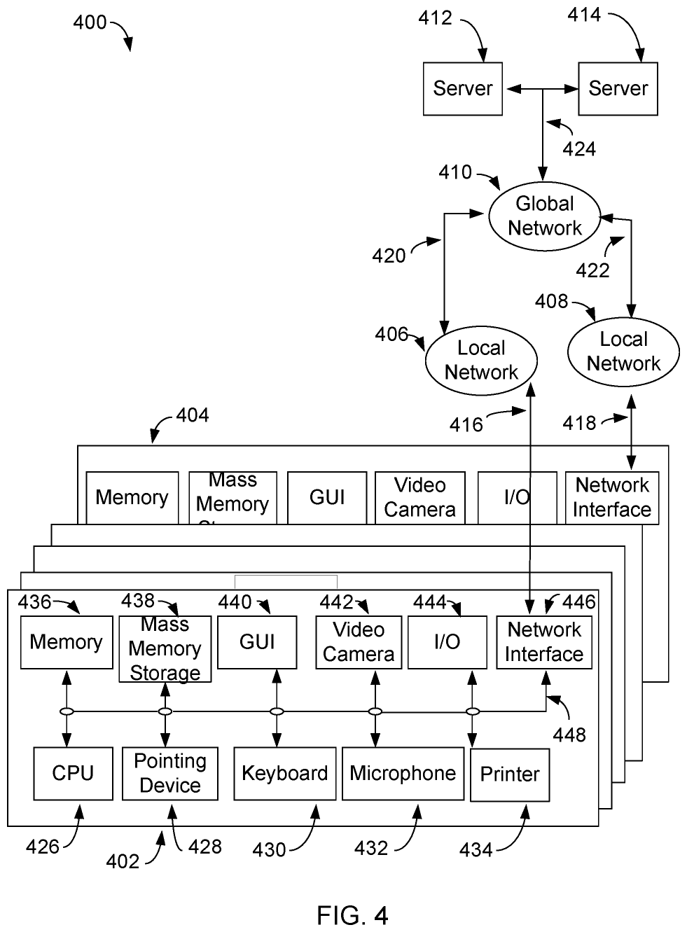

FIG. 4 is a block diagram depicting an exemplary client/server system which may be used by an exemplary web-enabled/networked embodiment of the present invention, suitable for executing a regionalized client/server communication system supporting location aware capabilities for providing motion and touch-screen motion commands, in accordance with an embodiment of the present invention.

A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448.

Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the disclosed system, other equivalent or alternative methods of implementing the method of shipping cargo/disclosed system will be apparent to those skilled in the art. Various aspects of the invention have been described above by way of illustration, and the specific embodiments disclosed are not intended to limit the invention to the particular forms disclosed. The particular implementation of the be method of shipping cargo may vary depending upon the particular context or application. By way of example, and not limitation, the be method of shipping cargo described in the foregoing were principally directed to shipping cargo via truck, airplane, boats, or other similar methods and implementations; however, similar techniques may instead be applied to moving cargo around a warehouse, storing cargo in storage facilities, finding cargo in a warehouse, and inputting the data generated from this system into other methods such as product ordering, stocking, and other similar systems. which implementations of the disclosed system are contemplated as within the scope of the disclosed system. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the disclosed system has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

It will be further apparent to those skilled in the art that at least a portion of the novel method steps and/or system components of the disclosed system may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the disclosed system. Thus, some alternate embodiments of the disclosed system may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the disclosed system. Depending upon the needs of the particular application, it will be readily apparent to those skilled in the art, in light of the teachings of the disclosed system, which aspects of the disclosed system can or should be located locally and which can or should be located remotely. Thus, for any claims construction of the following claim limitations that are construed under 35 USC § 112 (6)/(f) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6) pre-AIA or 35 USC § 112 (f) post AIA. In some embodiments, the methods and/or system components may be located and/or performed remotely.

It is noted that according to USA law, all claims must be set forth as a coherent, cooperating set of limitations that work in functional combination to achieve a useful result as a whole. Accordingly, for any claim having functional limitations interpreted under 35 USC § 112 (6)/(f) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6)/(f) is/(are) dependent on one or more remote servers located outside the USA, it is intended that each such recited function under 35 USC § 112 (6)/(f) is to be interpreted as the function of the local system receiving the remotely generated information required by a locally implemented claim limitation, wherein the structures and or steps which enable, and breath life into the expression of such functions claimed under 35 USC § 112 (6)/(f) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present patent application, and “35 USC § 112 (6)/(f)” should be replaced with the closest corresponding statute in the patent laws of such pertinent country or countries or legal organization(s).

What is claimed is:

1. A system for managing logistics of freight loading and movement comprising:
means for enabling carriers to see loads near their origin and destination areas;
means for enabling customers to order services based on empty space or load size;
means for an integrated application programming interface for multiple freight moving companies;
means for an integrated application programming interface for multiple storage companies;
means for optimizing bids by enabling users, via said application programming interface means, to search for services/products that accept bids; and
means for enabling users, via said application programming interface means, to find storage rooms and/or freight carriers with the lowest price per cubic foot.
